(19) United States
(12) Patent Application Publication
(10) Pub. No.: US 2026/0106484 A1
(43) Pub. Date: Apr. 16, 2026

(54) OUTPUT CURRENT CONTROL OF A UPS INVERTER FOR PROTECTION AGAINST BACK-FEED POWER

(71) Applicant: SCHNEIDER ELECTRIC IT CORPORATION, Foxboro, MA (US)

(72) Inventor: Jonas Sonsby Mouridsen, Odense V (DK)

(21) Appl. No.: 19/322,769

(22) Filed: Sep. 9, 2025

Related U.S. Application Data
(60) Provisional application No. 63/706,123, filed on Oct. 11, 2024.

(51) Int. Cl. H02J 9/06

(52) U.S. Cl. CPC H02J 9/06

(57) ABSTRACT

Examples of the disclosure include an uninterruptible power supply (UPS) comprising a first power path including a first input, a rectifier coupled to the first input, a DC bus coupled to the rectifier, an inverter coupled to the DC bus, and an output coupled to the inverter, a second power path including a bypass switching device and a second input selectively coupled to the output through the switching device, the second power path bypassing the first input, the rectifier, and the DC bus, and at least one controller configured to control the switching device to conduct power from the second input to the output, determine an operating quadrant of the inverter, determine a DC-bus voltage, and while the bypass switching device is conducting, limit a maximum magnitude of an output current of the inverter based at least in part on the operating quadrant and the DC-bus voltage.

### CROSS-REFERENCE TO RELATED APPLICATIONS

This application claims priority to U.S. Provisional Patent Application No. 63/706,123, titled “REDUCTION OF INVERTER CURRENT IN EQUAL QUADRANTS AT HIGH DC-BUS VOLTAGE,” filed on Oct. 11, 2024, the contents of which are incorporated herein by reference in their entirety for all purposes.

### BACKGROUND

### 1. Field of the Disclosure

At least one example in accordance with the present disclosure relates generally to uninterruptible power supplies.

### 2. Discussion of Related Art

Power devices, such as uninterruptible power supplies (UPSs), may be used to provide regulated, uninterrupted power for sensitive and/or critical loads, such as computer systems and other data-processing systems. UPSs may provide output power to a load. The output power may be derived from a primary source of power, such as a utility-mains source, and/or derived from a backup or secondary source of power, such as an energy-storage device. A UPS may include an inverter to convert DC power of at least one DC bus of the UPS into AC power and provide the AC power to the load via an output. The output of the UPS may be configured to be coupled to another source of power, such as a second utility-mains source, via a bypass power path to provide secondary power to the load when the UPS is under maintenance service.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phrascology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure, in one example, an uninterruptible power supply is provided comprising a first power path including a first input, a rectifier coupled to the first input, at least one DC bus coupled to the rectifier, an inverter coupled to the at least one DC bus, and an output coupled to the inverter; a second power path including a second input and a bypass switching device, the second input selectively coupled to the output through the bypass switching device, the second power path bypassing the first input, the rectifier, and the at least one DC bus; and at least one controller configured to control the bypass switching device to be in a conducting state to conduct power from the second input to the output, determine an operating quadrant of the inverter, determine a voltage of the at least one DC bus, and while the bypass switching device is in the conducting state, limit a maximum magnitude of an output current of the inverter based at least in part on the operating quadrant and the voltage of the at least one DC bus.

In at least one example, determining the operating quadrant of the inverter includes receiving a sense signal of a voltage at the output and determining a requested output current of the inverter. In at least one example, the at least one controller is further configured to determine whether a magnitude of the voltage of the at least one DC bus is above a voltage threshold, and limiting the maximum magnitude of the output current of the inverter based at least in part on the operating quadrant and the voltage of the at least one DC bus is performed in response to determining that the magnitude of the voltage of the at least one DC bus is above the voltage threshold. In at least one example, limiting the maximum magnitude of the output current of the inverter based at least in part on the operating quadrant and the voltage of the at least one DC bus is performed based on a linear scaling factor between the maximum magnitude of the output current of the inverter and the magnitude of the voltage of the at least one DC bus.

In at least one example, the voltage threshold corresponds to at least one of a shutdown threshold of the inverter or a voltage rating level of a capacitive element coupled to the at least one DC bus. In at least one example, limiting the maximum magnitude of the output current of the inverter includes limiting a maximum magnitude of a crest factor of the output current of the inverter. In at least one example, limiting the maximum magnitude of the output current of the inverter based at least in part on the operating quadrant and the voltage of the at least one DC bus is performed in response to determining that the operating quadrant is a quadrant in which power conducts into the inverter from the second input. In at least one example, the operating quadrant is a quadrant in which an output voltage of the inverter and the output current of the inverter have opposite polarities.

In at least one example, limiting the maximum magnitude of the output current of the inverter is performed further based on a net power output of the UPS within a line cycle of the inverter. In at least one example, limiting the maximum magnitude of the output current of the inverter further based on the net power output of the UPS within the line cycle of the inverter includes determining that the net power output of the UPS within the line cycle of the inverter is negative. In at least one example, the at least one DC bus includes a positive DC bus and a negative DC bus, and limiting the maximum magnitude of the output current of the inverter includes balancing a voltage of the positive DC bus and a voltage of the negative DC bus within a line cycle of the inverter. In at least one example, the first power path further includes a DC/DC converter coupled to the at least one DC bus and configured to be coupled to an energy-storage device.

Examples of the disclosure include at least one non-transitory computer-readable medium storing thereon sequences of computer-executable instructions for operating an uninterruptible power supply (UPS), the UPS including a first power path including a first input, a rectifier coupled to the first input, at least one DC bus coupled to the rectifier, an inverter coupled to the at least one DC bus, and an output coupled to the inverter, and a second power path including a second input and a bypass switching device, the second input coupled to the output through the bypass switching device, the second power path bypassing the first input, the rectifier, and the at least one DC bus, the sequences of computer-executable instructions including instructions that instruct at least one processor to: control the bypass switching device to be in a conducting state to conduct power from the second input to the output; determine an operating quadrant of the inverter; determine a voltage of the at least one DC bus; and while the bypass switching device is in the conducting state, limit a maximum magnitude of an output current of the inverter based at least in part on the operating quadrant and the voltage of the at least one DC bus.

In at least one example, determining the operating quadrant of the inverter includes receiving a sense signal of a voltage at the output and determining a requested output current of the inverter. In at least one example, the instructions further instruct the at least one processor to determine whether a magnitude of the voltage of the at least one DC bus is above a voltage threshold, and limiting the maximum magnitude of the output current of the inverter based at least in part on the operating quadrant and the voltage of the at least one DC bus is performed in response to determining that a magnitude of the voltage of the at least one DC bus is above a voltage threshold.

In at least one example, limiting the maximum magnitude of the output current of the inverter based at least in part on the operating quadrant and the voltage of the at least one DC bus is performed based on a linear scaling factor between the maximum magnitude of the output current of the inverter and the magnitude of the voltage of the at least one DC bus. In at least one example, the voltage threshold corresponds to at least one of a shutdown threshold of the inverter or a voltage rating level of a capacitive element coupled to the at least one DC bus. In at least one example, limiting the maximum magnitude of the output current of the inverter based at least in part on the operating quadrant and the voltage of the at least one DC bus is performed in response to determining that the operating quadrant is a quadrant in which power conducts into the inverter from the second input. In at least one example, the operating quadrant is a quadrant in which an output voltage of the inverter and the output current of the inverter have opposite polarities.

Examples of the disclosure include a method of operating an uninterruptible power supply (UPS), the UPS including a first power path including a first input, a rectifier coupled to the first input, at least one DC bus coupled to the rectifier, an inverter coupled to the at least one DC bus, and an output coupled to the inverter, and a second power path including a second input and a bypass switching device, the second input coupled to the output through the bypass switching device, the second power path bypassing the first input, the rectifier, and the at least one DC bus, the method comprising: providing, by the bypass switching device, power from the second input to the output; determining an operating quadrant of the inverter; determining a voltage of the at least one DC bus; and while providing, by the bypass switching device, the power from the second input to the output, limiting a maximum magnitude of an output current of the inverter based at least in part on the operating quadrant and the voltage of the at least one DC bus.

Examples of the disclosure include at least one non-transitory computer-readable medium storing thereon sequences of computer-executable instructions for operating an uninterruptible power supply (UPS), the UPS including at least one DC bus, an inverter coupled to at least one DC bus, and an output coupled to the inverter and configured to be coupled to at least one load, the sequences of computer-executable instructions including instructions that instruct at least one processor to: control the inverter to draw power from the at least one load; determine an operating quadrant of the inverter; determine a voltage of the at least one DC bus; and limit a maximum magnitude of an output current of the inverter derived from the power drawn from the at least one load based at least in part on the operating quadrant and the voltage of the at least one DC bus.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of an uninterruptible power supply (UPS) according to an example;

FIG. 2 illustrates a schematic diagram of a four-quadrant operation of an inverter according to an example;

FIG. 3 illustrates a control diagram to limit the magnitude of the output current of an inverter within the second and fourth operating quadrants of the inverter according to an example;

FIG. 4 illustrates a graph showing output current limit control of an inverter within the second and fourth operating quadrants of the inverter according to an example;

FIG. 5A illustrates output current variation of an inverter without output current limit control within the four-quadrant operation of the inverter according to an example;

FIG. 5B illustrates modified output current variation of an inverter with output current limit control within the four-quadrant operation of the inverter according to an example;

FIG. 6 illustrates a control process to limit the maximum magnitude of the output current of an inverter according to an example; and

FIG. 7 illustrates a control process to limit the maximum magnitude of the output current of an inverter according to an example.

### DETAILED DESCRIPTION

As discussed above, an uninterruptible power supply (UPS) may be used to provide regulated, uninterruptible power to one or more external loads at an output of the UPS. An example UPS may include at least two inputs. A first input is configured to be coupled to a primary power source (including, for example, a first utility mains supply), and a second input is configured to be coupled to a secondary power source (including, for example, one or more energy-storage devices, such as batteries). If acceptable power is available from the primary power source, the UPS may draw power from the primary power source along a first power path from the first input to the output. This mode of operation may be referred to as an online mode. If acceptable power is not available from the primary power source, the UPS may draw power from the secondary power source along a second power path from the second input to the output. This mode of operation may be referred to as a battery mode.

The first and second power paths may each pass through one or more converters, such as rectifiers, power factor correction (PFC) converters, DC/AC converters (also referred to as inverters), and/or DC/DC converters. For some example UPSs, the first power path may extend from the first input to the output through a rectifier, a PFC, at least one DC bus, and an inverter, and the second power path may extend from the second input to the output through a DC/DC converter, the at least one DC bus, and the inverter.

In various examples, to prevent power interruption to the one or more external loads at the output of the UPS, the output of the UPS is selectively coupled to a third power source including, for example, a second utility mains supply. The second utility mains supply may bypass the primary power source and the secondary power source. If the UPS is under maintenance service, the one or more external loads may draw power from the third power source through a third power path that includes the output of the UPS.

In some examples, back-feed power may flow from the third power source into the inverter within certain operating quadrants of the inverter during a transient period as the third power source is turned on. This back-feeding may cause shutdowns or damage to the inverter. In addition, in some examples, the one or more external loads may be reactive and direct back-feed power into the inverter. If the inverter is not completely shut down, the back-feed power may also lead to an excessively high voltage across one or more capacitive elements (for example, capacitors) coupled to the at least one DC bus and consequently damage the one or more capacitive elements (for example, by exceeding the voltage rating of the one or more capacitive elements). Such capacitor damage may occur when, for example, the back-feed power is not dissipated from the UPS to the primary power source or the secondary power source. The inverter may be shut down in response to the high back-feed power, which may lead to undesirable UPS downtime.

Similarly, back-feed power may flow from a load back into the inverter. For example, the load may include a regenerative load, such as a motor, that feeds regenerative power back to the inverter. If a large amount of regenerative power is backfed to the inverter, an excessively high voltage may accumulate across the one or more capacitive elements.

Examples of the present disclosure include systems and methods to control the inverter of the UPS within at least one or more of the operating quadrants of the inverter to minimize inverter downtime and prevent damage to the inverter and the one or more capacitive elements coupled to the at least one DC bus. For example, this control of the inverter may be executed when the third power source and/or a regenerative load provides power to the one or more external loads.

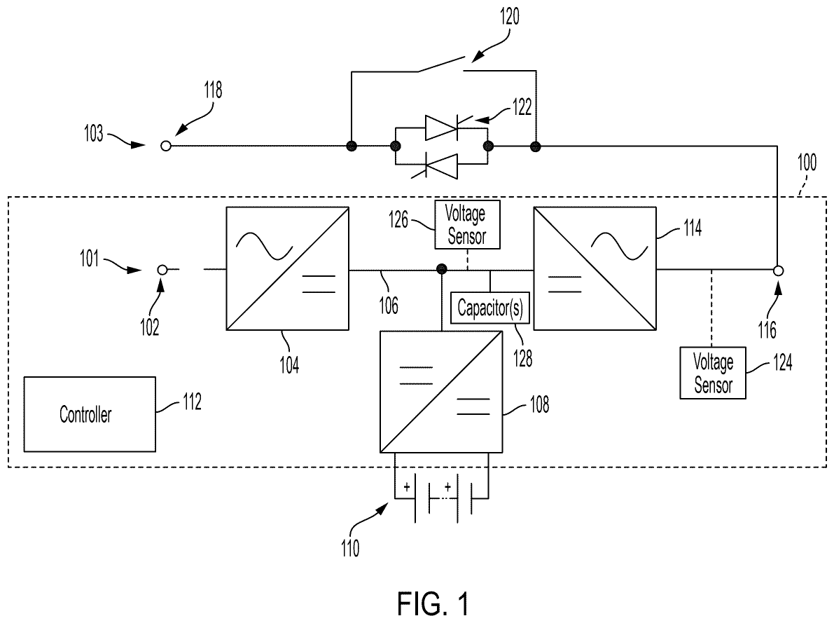

FIG. 1 illustrates a block diagram of a UPS 100 according to an example. The UPS 100 may include a first power path 101. The first power path 101 includes a first input 102, a rectifier 104, at least one DC bus 106, a DC/DC converter 108, at least one controller 112 (“controller 112”), an inverter 114, and an output 116. The UPS 100 may further include a first voltage sensor 124 coupled to the output 116, a second voltage sensor 126 coupled to the at least one DC bus 106, and one or more capacitors 128 (“DC-bus capacitors 128”) coupled to the at least one DC bus 106. The first voltage sensor 124 and the second voltage sensor 126 may be communicatively coupled to the controller 112 and send sense signals to the controller 112.

The input 102 may be coupled to the rectifier 104 and configured to be coupled to a primary AC power source (not illustrated), such as a first AC mains power supply. The rectifier 104 may be coupled to the input 102 at an input connection and to the at least one DC bus 106 at an output connection. The rectifier 104 may be communicatively coupled to the controller 112. The at least one DC bus 106 may be coupled to the rectifier 104, a first connection of the DC/DC converter 108, the one or more capacitors 128, and an input connection of the inverter 114. A second connection of the DC/DC converter 108 may be configured to be coupled to at least one energy-storage device 110. In some examples, the UPS 100 may be internal to or external to the at least one energy-storage device 110. In other examples, the UPS 100 may include the at least one energy-storage device, which may include one or more batteries, capacitors, flywheels, or other energy-storage devices in various examples.

The inverter 114 is coupled to the rectifier 104, the DC/DC converter 108, and the output 116. An output connection of the inverter 114 may be coupled to the output 116. The inverter 114 may be communicatively coupled to the controller 112. The output 116 may be coupled to an external load (not illustrated). In some examples, the external load may include a regenerative load, such as a motor. In some examples, the controller 112 may be communicatively coupled to the rectifier 104, the DC/DC converter 108, the inverter 114, the first voltage sensor 124, and the second voltage sensor 126.

As noted above, the output 116 of the UPS 100 may also be coupled to a secondary AC power source through a second power path 103 to provide backup power to the external load in a bypass mode (for example, when the UPS 100 is under maintenance service). In this example, the second power path 103 includes a second input 118, a maintenance bypass breaker (MBB) 120, a bypass switch 122, and the output 116. In some examples, the bypass switch 122 may be a static bypass switch. The second input 118 is coupled to the MBB 120 and the bypass switch 122 and configured to be coupled to a secondary AC power source (not illustrated), such as a second AC mains power supply. The MBB 120 and the bypass switch 122 may be coupled to each other in parallel, and both may be coupled to the inverter 114 and the output 116. Controlling one of the MBB 120 or the bypass switch 122 to be closed (that is, in a conducting state) may conduct power from the second input 118 to the output 116 through the corresponding one of the MBB 120 or the bypass switch 122. Accordingly, the second input 118 may be selectively coupled to the output 116 through a bypass switching device while the bypass switching device is in a conducting state, such as the MBB 120 and/or the bypass switch 122. At least one of the MBB 120 or the bypass switch 122 may be manually controlled or communicatively coupled to the controller 112. In some examples, the UPS 100 may include the MBB 120 and the second input 118. In some examples, the bypass switch 122 may be external to the UPS 100. In certain examples, the second power path 103 may not include one of the MBB 120 or the bypass switch 122. In various examples, each of the MBB 120 and the bypass switch 122 may be referred to as a bypass switching device.

The second power path 103 may be configured to bypass at least a portion of the UPS 100, including, for example, the input 102, the rectifier 104, the at least one DC bus 106, and the DC/DC converter 108. When the UPS 100 is under maintenance service, a user or the controller 112 may close (or connect) one of the MBB 120 or the bypass switch 122 to provide secondary power from the second input 118 to the output 116. Because the output connection of the inverter 114 is coupled to the output 116, the output connection of the inverter 114 may be inadvertently coupled to the second input 118. Furthermore, in some examples, the inverter 114 may absorb regenerative power from the external load coupled to the output 116.

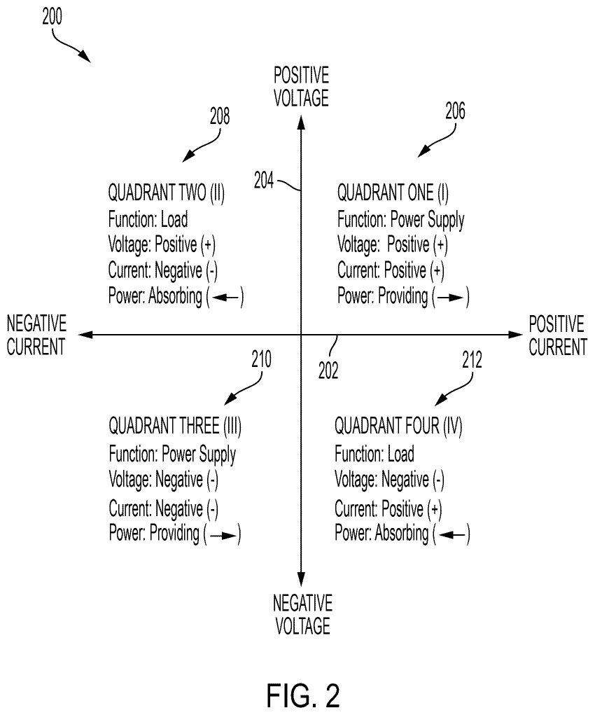

As described above, this may allow back-feed power to flow into the inverter 114 within certain operating quadrants (as discussed in greater detail below with respect to FIG. 2), which may lead to undesirable shutdown of the inverter 114 and/or cause damage to the inverter 114 and/or the DC-bus capacitors 128 coupled to the at least one DC bus 106. Details of the back-feed power flow and the corresponding control method to prevent inverter and capacitor damage and/or shutdown are described below.

FIG. 2 illustrates a schematic diagram 200 of a four-quadrant operation of the inverter 114 of the UPS 100 according to an example. In this example, the operation of the inverter 114 may include four operating quadrants or modes, each corresponding to a different set of operational parameters and power flows. As described above, in one example, the inverter 114 may operate within the four operating quadrants when the MBB 120 is conducting and power on the second power path 103 is out of phase with power on the first power path 101. A horizontal axis 202 depicts an output current of the inverter 114. The right half of the horizontal axis 202 depicts positive output currents of the inverter 114 (“POSITIVE CURRENT”), which corresponds to output currents flowing out of the inverter 114 and towards the output 116 along the first power path 101. The left half of the horizontal axis 202 depicts negative output currents of the inverter 114 (“NEGATIVE CURRENT”), which corresponds to back-feed currents flowing into the inverter 114 from the second input 118 and/or the output 116 along the second power path 101. A vertical axis 204 depicts an output voltage of the inverter 114, which is also the voltage at the output 116. The top half of the vertical axis 204 depicts positive output voltages of the inverter 114 (“POSITIVE VOLTAGE”), and the bottom half of the vertical axis 204 depicts negative output voltages of the inverter 114 (“NEGATIVE VOLTAGE”).

Within a first operating quadrant 206 (“QUADRANT ONE [I]”) of the inverter 114, both the output voltage and the output current of the inverter 114 are positive, indicating that the UPS 100 is providing power to the output 116 and functioning as a power supply. Within a second operating quadrant 208 (“QUADRANT TWO [II]”) of the inverter 114, the output voltage of the inverter 114 is positive and the output current of the inverter 114 is negative (that is, an opposite polarity), indicating that the UPS 100 is absorbing back-feed power and functioning as a load. The back-feed power may be from at least one of the second input 118 or the one or more external loads (for example, via the output 116). Within a third operating quadrant 210 (“QUADRANT THREE [III]”) of the inverter 114, both the output voltage and the output current of the inverter 114 are negative, indicating that the UPS 100 is providing power to the output 116 and functioning as a power supply. Within a fourth operating quadrant 212 (“QUADRANT FOUR [IV]”) of the inverter 114, the output voltage of the inverter 114 is negative and the output current of the inverter 114 is positive (that is, an opposite polarity), indicating that the UPS 100 is absorbing back-feed power and functioning as a load. The back-feed power may be from at least one of the second input 118 or the one or more external loads (for example, via the output 116).

Because the inverter 114 absorbs back-feed power within the second quadrant 208 and the fourth quadrant 212, the inverter 114, and DC-bus capacitors 128 coupled to the at least one DC bus 106 may be damaged in certain circumstances. For example, if the inverter 114 operates within the second operating quadrant 208 and/or the fourth operating quadrant 212 for an extended period of time, the inverter 114 may absorb more back-feed power than the inverter 114 is rated to handle. In some situations, the inverter 114 may shutdown in response to the high back-feed power. Examples of the present disclosure include a method to control the inverter 114 within the second quadrant 208 and/or the fourth quadrant 212 by limiting a magnitude of the output current of the inverter 114 to protect the inverter 114 and the DC-bus capacitors 128.

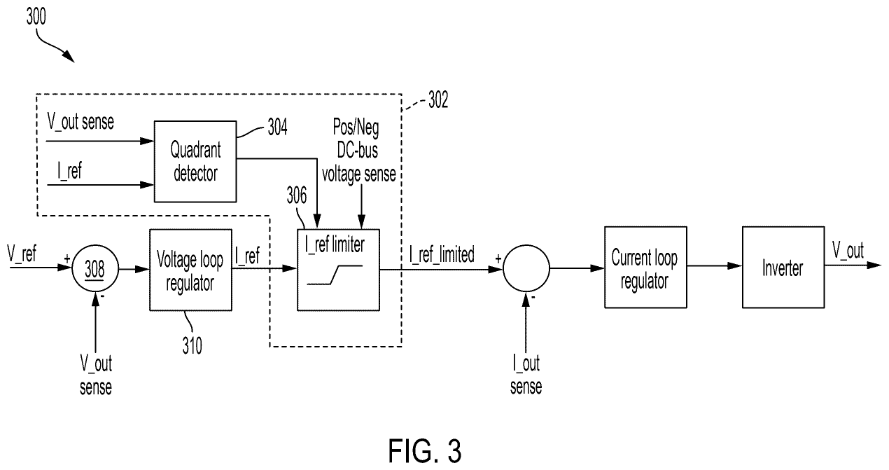

FIG. 3 illustrates a control diagram 300 of the controller 112 to limit the magnitude of the output current of the inverter 114 within the second operating quadrant 208 and the fourth operating quadrant 212 of the inverter 114 according to an example. The control diagram 300 includes a logic portion 302 that allows the controller 112 to determine the current operating quadrant of the inverter 114 and limit the output current of the inverter 114 in a controlled manner when the inverter 114 is operating within the second operating quadrant 208 and/or the fourth operating quadrant 212.

In one example, the logic portion 302 includes a quadrant detector 304 and a reference current limiter 306 (“I_ref limiter”). The quadrant detector 304 determines the current operating quadrant of the inverter 114 according to the schematic diagram 200 in FIG. 2 based on an output voltage (“V_out sense”) of the inverter 114 sensed by the first voltage sensor 124 and a reference current (“I_ref”) of the inverter 114 determined by a voltage loop regulator 310. The reference current (“I_ref”) of the inverter 114 is a requested output current and/or a requested change in the output current of the inverter 114 for the corresponding output voltage of the inverter 114 to match a voltage at the output 116. The reference current (“I_ref”) of the inverter 114 may be determined via a summation block 308 and the voltage loop regulator 310 based on a difference between a reference voltage (“V_ref”) and the output voltage of the inverter 114 (“V_out sense”). The reference voltage (“V_ref”) is a requested output current and/or a requested change in the output voltage of the inverter 114 for the output voltage of the inverter 114 to match the voltage at the output 116.

The reference current limiter 306 (“I_ref limiter”) modifies the reference current (“I_ref”) of the inverter 114 into a limited reference current (“I_ref_limited”) based on the operating quadrant determined by the quadrant detector 304, a DC-bus voltage (“Pos/Neg DC-bus voltage sense”) of the at least one DC bus 106 sensed by the second voltage sensor 126, and the reference current (“I_ref”) of the inverter 114 determined by the voltage loop regulator 310. As discussed further below, when the inverter 114 operates within the second operating quadrant 208 or the fourth operating quadrant 212, the reference current limiter 306 (“I_ref limiter”) may set a maximum limit on the magnitude of the output current of the inverter 114 during a period within the corresponding operating quadrant so as to prevent the inverter 114 and the DC-bus capacitors 128 from absorbing excessively high back-feed power.

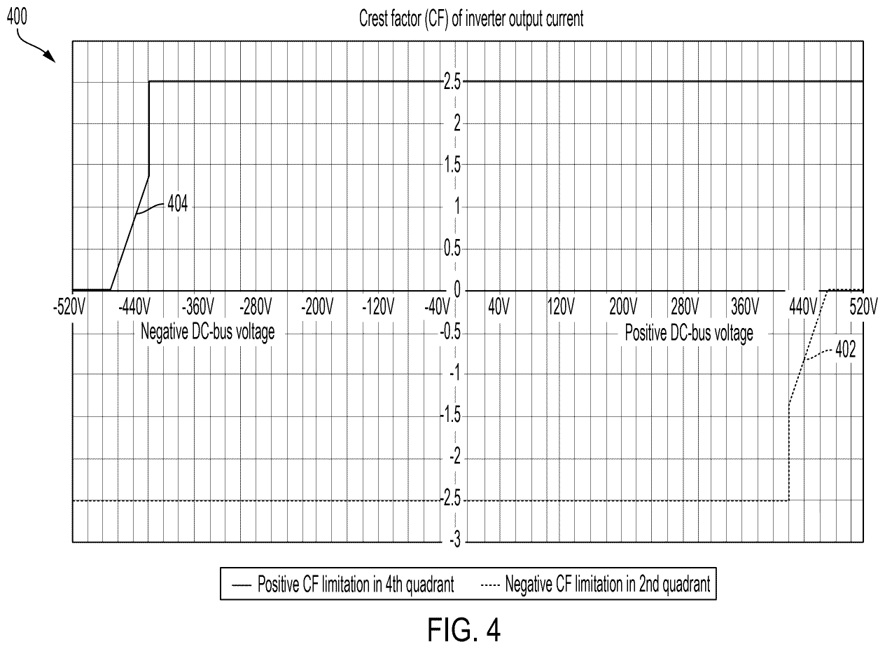

FIG. 4 illustrates a graph 400 showing output current limit control over the inverter 114 based on a DC-bus voltage of the at least one DC bus 106 within the second and fourth operating quadrants of the inverter 114 of the UPS 100 according to an example. In various examples, the controller 112 may limit the output current of the inverter 114 at least in part by limiting a crest factor (that is, the ratio of the peak current to the root-mean-square [RMS] current) of the output current in the second operating quadrant 208 and the fourth operating quadrant 212 of the inverter 114. For example, the controller 112 may limit the output current by imposing a maximum crest factor that varies at least in part based on the output voltage of the inverter 114. Because the UPS 100 does not absorb back-feed power within the first operating quadrant 206 and the third operating quadrant 210, the crest factor of the output current of the inverter 114 may not be limited by the controller 112 within the first operating quadrant 206 and the third operating quadrant 210.

Within the second operating quadrant 208, in one example, because the UPS 100 is absorbing back-feed power via the inverter 114, the controller 112 may limit the crest factor of the output current of the inverter 114 based on a voltage of the at least one DC bus 106 as indicated by a first trace 402. The controller 112 may implement multiple different operating schemes to control the crest factor based on the voltage of the at least one DC bus 106. In some examples, depending on the thermal tolerance of the inverter 114, the inverter 114 may be configured to temporarily shut down at a first-level threshold voltage and permanently shut down at a second-level threshold voltage that is higher than the first-level threshold voltage. If the voltage of the at least one DC bus 106 is below the first-level threshold voltage (for example, 420 V), the controller 112 may operate in a first operating scheme in which the controller 112 implements a constant maximum crest factor (for example, having a magnitude of 2.5 corresponding to a crest factor of −2.5).

If the voltage of the at least one DC bus 106 is above the first-level threshold voltage but below the second-level threshold voltage (for example, 470 V), the controller 112 may operate in a second operating scheme in which the controller 112 varies the maximum crest factor based on the voltage of the at least one DC bus 106. For example, the controller 112 may vary the maximum crest factor between a first value (for example, having a magnitude of 1.4 corresponding to a crest factor of −1.4) and a second value (for example, 0) based on the voltage of the at least one DC bus 106 (for example, based on a linear scaling factor with respect to the voltage). If the voltage of the at least one DC bus 106 is above the second-level threshold voltage, the controller 112 may turn the inverter 114 off or otherwise control the inverter 114 to not output any current.

Limiting the output current in this manner reduces a risk of the inverter 114 absorbing high back-feed power and that of the DC-bus capacitors 128 accumulating high charges by fluctuating back-feed power that causes the inverter 114 to automatically turn on and off repeatedly within a short period. For example, if the DC-bus voltage fluctuates across the first-level threshold voltage without reaching the second-level threshold voltage, the inverter 114 may be temporarily shut down when the DC-bus voltage is above the first-level threshold voltage and still below the second-level threshold voltage, and then restarted when the DC-bus voltage quickly drops below the first-level threshold voltage. If the output current of the inverter 114 is high while the inverter 114 is restarted, such iteration may charge up the DC-bus capacitors 128 quickly over time and cause capacitor damage. Therefore, limiting the output current of the inverter 114 protects the DC-bus capacitors 128 from overcharging. Accordingly, a maximum current limit may be set based at least in part on a shutdown threshold of the inverter 114 and/or a voltage rating level of a capacitive element coupled to the at least one DC bus 106 (for example, one or more of the DC-bus capacitors 128).

In other examples, within the second operating quadrant 208, the controller 112 may limit the magnitude of the crest factor of the output current of the inverter 114 in other manners. For example, the controller 112 may gradually limit the magnitude of the crest factor in a non-linear way, such as based on a power function.

Similarly, within the fourth operating quadrant 212, because the UPS 100 is absorbing back-feed power via the inverter 114, the controller 112 may limit the crest factor of the output current of the inverter 114 based on a voltage of the at least one DC bus 106 as indicated by a second trace 404. The controller 112 may implement multiple different operating schemes to control the crest factor based on the voltage of the at least one DC bus 106. If the voltage of the at least one DC bus 106 is above a first threshold voltage (for example, −420 V), the controller 112 may operate in a first operating scheme in which the controller 112 implements a constant maximum crest factor (for example, having a magnitude of 2.5 corresponding to a crest factor of 2.5).

If the voltage of the at least one DC bus 106 is below the first threshold voltage but above a second threshold voltage (for example, −470 V), the controller 112 may operate in a second operating scheme in which the controller 112 varies the maximum crest factor based on the voltage of the at least one DC bus 106. For example, the controller 112 may vary the maximum crest factor between a first value (for example, having a magnitude of 1.4 corresponding to a crest factor of 1.4) and a second value (for example, 0) based on the voltage of the at least one DC bus 106 (for example, based on a linear relationship with the voltage). If the voltage of the at least one DC bus 106 is below the second threshold voltage, the controller 112 may turn the inverter 114 off or otherwise control the inverter 114 to not output any current.

In other examples, within the fourth operating quadrant 212, the controller 112 may limit the magnitude of the crest factor of the output current of the inverter 114 in other manners. For example, the controller 112 may gradually limit the magnitude of the crest factor in a non-linear way, such as based on a power function.

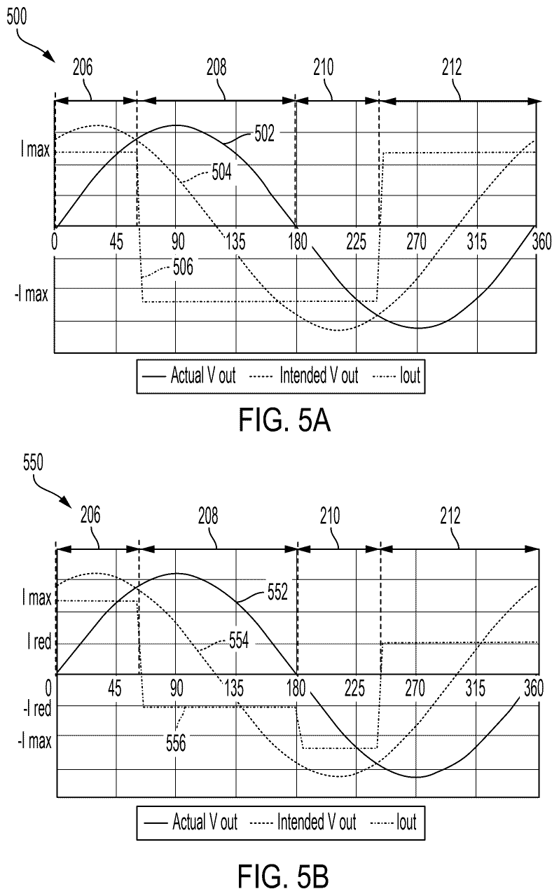

FIG. 5A illustrates a graph 500 of an output current variation of the inverter 114 of the UPS 100 without output current limit control according to an example. In this example, because the original power output of the inverter 114 depicted by an actual output voltage curve 502 (“Actual Vout”) is phase-shifted from the secondary power derived from the second input 118 depicted by an intended output voltage trace 504 (“Intended Vout”), the inverter 114 operates through the four operating quadrants 206, 208, 210, 212 to try to match the actual output voltage of the inverter 114 with the intended output voltage in a conventional manner. The graph 500 depicts a complete 360° line cycle of the output of the inverter 114, such that the actual output voltage curve 502 and the intended output voltage trace 504 are each depicted over a complete 360° sinusoidal line cycle.

Because of the large difference between the actual output voltage curve 502 and the intended output voltage trace 504 throughout much of the line cycle of the inverter 114, the controller 112 may control the inverter 114 to output a maximum output current in each operating quadrant. An output current trace 506 indicates an output current of the inverter 114. Within the first operating quadrant 206 and the fourth operating quadrant 212, because the intended output voltage indicated by the intended output voltage trace 504 is higher than the actual output voltage indicated by the actual output voltage curve 502, the controller 112 operates the inverter 114 to output a highest magnitude positive output current (“Imax”) having a maximized magnitude for a large portion of the operating quadrants 206, 212 (except, for example, close to the transitions in and out of the operating quadrants 206, 212 when the intended output voltage trace 504 and the output current trace 506 are similar in value).

Within the second operating quadrant 208 and the third operating quadrant 210, because the intended output voltage indicated by the intended output voltage trace 504 is lower than the actual output voltage indicated by the output current trace 506, the inverter 114 operates to produce a highest magnitude negative output current (“−Imax”) having a maximized magnitude for a large portion of the operating quadrants 208, 210 (except, for example, close to the transitions in and out of the operating quadrants 208, 210 when the intended output voltage trace 504 and the output current trace 506 are similar in value). As described above, the output current of the inverter 114 within the second operating quadrant 208 and the fourth operating quadrant 212, represents back-feed power into the inverter 114. In this example, because the second operating quadrant 208 and the fourth operating quadrant 212 extend over longer periods than the first operating quadrant 206 and the third operating quadrant 210 within the depicted line cycle of the inverter 114, the back-feed power may be significant (and, in some examples, detrimental) and may lead to a negative net power output of the inverter 114 over the depicted line cycle of the inverter 114.

FIG. 5B illustrates a graph 550 of a modified output current variation of the inverter 114 of the UPS 100 with output current limit control according to an example. The graph 550 includes an actual output voltage trace 552 (“Actual Vout”), an intended output voltage trace 554 (“Intended Vout”), and an inverter output current trace 556 (“Iout”). Under the output current limit control, the controller 112 limits the output current of the inverter 114 within the second operating quadrant 208 and the fourth operating quadrant 212 as indicated by the inverter output current trace 556.

In one example, the controller 112 may operate the inverter 114 to limit the output current of the inverter 114 within the second operating quadrant 208 to a reduced maximum current level (“−Ired”), as indicated by the inverter output current trace 556. The reduced maximum current level (“−Ired”) may have a lower magnitude than the highest magnitude negative output current (“−Imax”) of the output current trace 506 in the second operating quadrant 208.

Similarly, the controller 112 may operate the inverter 114 to limit the output current of the inverter 114 within the fourth operating quadrant 212 to a reduced maximum current level (“Ired”), as indicated by the inverter output current trace 556. The reduced maximum current level (“Ired”) may have a lower magnitude than the highest magnitude positive output current (“Imax”) of the output current trace 506 in the third operating quadrant 210. The reduced magnitude of the output current of the inverter 114 within the second operating quadrant 208 and the fourth operating quadrant 212 may prevent the inverter 114 and the DC-bus capacitors from being damaged by the back-feed power.

In some examples, the at least one DC bus 106 may include a positive DC bus and a negative DC bus. In these examples, the controller 112 may limit the respective output current of the positive and negative DC buses individually and thereby balance the respective voltage of the positive and negative DC buses.

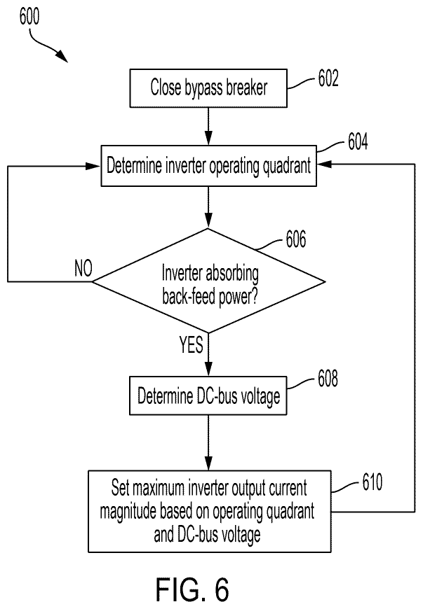

FIG. 6 illustrates a control process 600 to limit the maximum magnitude of the output current of the inverter 114 of the UPS 100 according to an example. The controller 112 may execute the process 600. For example, the controller 112 may execute the process 600 to protect the inverter 114 and the DC-bus capacitors from back-feed power damage and prevent or minimize inverter shutdown from bypass power received from a bypass switching device in some examples.

At act 602, in one example, the controller 112 may close (or connect) a bypass switching device (such as the MBB 120 or the bypass switch 122) to conduct secondary power from the second input 118 to the output 116 along the second power path 103. For example, the controller 112 may close the bypass switching device such that power from the second input 118 is provided to the output 116, bypassing components of the UPS 100.

At act 604, in one example, the controller 112 may determine a current operating quadrant of the inverter 114. As described above with respect to FIG. 3, the controller 112 may determine the current operating quadrant based on the output voltage of the inverter 114 and the reference current of the inverter 114. In some examples, the controller 112 may determine the output voltage of the inverter 114 based on voltage information from the voltage sensor 124 and/or the voltage sensor 126. For example, the controller 112 may receive a sense signal indicative of a voltage at the output 116.

At act 606, in one example, the controller 112 may determine whether the inverter 114 is absorbing back-feed power within the current operating quadrant. If the controller 112 determines that the inverter 114 is not absorbing back-feed power (that is, the current operating quadrant is the first operating quadrant 206 or the third operating quadrant 210) (606 NO), the control process 600 returns to the act 604. On the other hand, if the controller 112 determines that the inverter 114 is absorbing back-feed power (that is, the current operating quadrant is the second operating quadrant 208 or the fourth operating quadrant 212) (606 YES), the control process 600 proceeds to act 608.

At act 608, in one example, the controller 112 may determine a DC-bus voltage of the at least one DC bus 106. For example, the second voltage sensor 126 may sense voltage information indicative of the voltage of the at least one DC bus 106 and provide the sensed voltage information to the controller 112. The controller 112 may determine the voltage of the at least one DC bus 106 based on the sensed voltage information. In some examples, act 608 may be optionally executed. For example, the controller 112 may determine the voltage information based on sensed voltage information received from the first voltage sensor 124 at act 604 in some examples.

At act 610, in one example, the controller 112 may set a maximum magnitude of the output current of the inverter 114 based on the current operating quadrant and the DC-bus voltage. As described above with respect to FIG. 3, the controller 112 may set the maximum magnitude of the output current of the inverter 114 based on the reference current limiter 306. The control process 600 may then return to the act 604.

Certain acts of the control process 600 are described as occurring in sequence solely for purposes of explanation rather than limitation. In many implementations, certain acts of the process 600 may be executed in different orders and/or in parallel with one another. Accordingly, no limitation is implied by the order of the acts in the process 600.

In various examples, the control process 600 may be implemented on other inverters of four-quadrant operations, but unrelated to UPSs, to protect the inverters from back-feed power damage and/or unintended shutdown of the inverter.

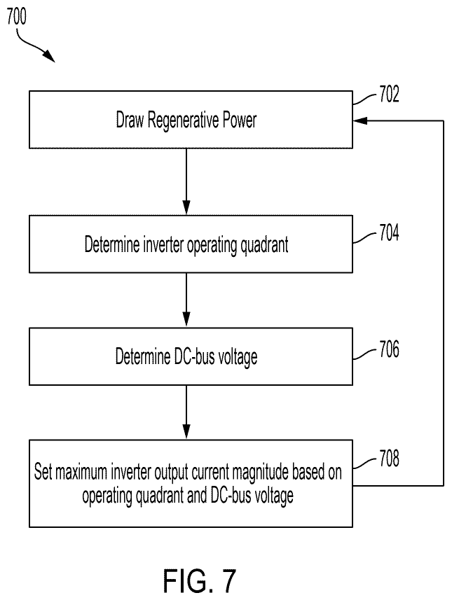

As discussed above, in some examples, the inverter 114 may absorb regenerative backfeed power from an external load coupled to the output 116. FIG. 7 illustrates a control process 700 to limit the maximum magnitude of the output current of the inverter 114 of the UPS 100 according to an example. The controller 112 may execute the process 700. For example, the controller 112 may execute the process 700 to protect the inverter 114 and the DC-bus capacitors from back-feed power damage and prevent or minimize inverter shutdown from backfeed power received from a regenerative load in some examples.

At act 702, in one example, the controller 112 may control the inverter 114 to draw power from the output 116. For example, the controller 112 may control the inverter 114 to draw regenerative power from an external load coupled to the output 116, such as a motor.

At act 704, in one example, the controller 112 may determine a current operating quadrant of the inverter 114. As described above with respect to FIG. 3, the controller 112 may determine the current operating quadrant based on the output voltage of the inverter 114 and the reference current of the inverter 114. In some examples, the controller 112 may determine the output voltage of the inverter 114 based on voltage information from the voltage sensor 124 and/or the voltage sensor 126.

At act 706, in one example, the controller 112 may determine a DC-bus voltage of the at least one DC bus 106. For example, the second voltage sensor 126 may sense voltage information indicative of the voltage of the at least one DC bus 106 and provide the sensed voltage information to the controller 112. The controller 112 may determine the voltage of the at least one DC bus 106 based on the sensed voltage information. In some examples, act 708 may be optionally executed. For example, the controller 112 may determine the voltage information based on sensed voltage information received from the first voltage sensor 124 at act 704 in some examples.

At act 708, in one example, the controller 112 may set a maximum magnitude of the output current of the inverter 114 based on the current operating quadrant and the DC-bus voltage. As described above with respect to FIG. 3, the controller 112 may set the maximum magnitude of the output current of the inverter 114 based on the reference current limiter 306. The output current may be current output to the at least one DC bus 106 and derived from the power drawn from the output 116. The control process 700 may then return to the act 702.

Certain acts of the control process 700 are described as occurring in sequence solely for purposes of explanation rather than limitation. In many implementations, certain acts of the process 700 may be executed in different orders and/or in parallel with one another. Accordingly, no limitation is implied by the order of the acts in the process 700.

In various examples, the control process 700 may be implemented on other inverters of four-quadrant operations, but unrelated to UPSs, to protect the inverters from back-feed power damage and/or unintended shutdown of the inverter.

Various controllers, such as the controller 112, may execute various operations discussed above. The controller 112 may also execute one or more computer-executable instructions stored on one or more non-transitory computer-readable media, which the controller 112 may include and/or be coupled to, which may result in manipulated data. The non-transitory computer-readable media may include memory and/or storage. In some examples, the controller 112 may include one or more processors or other types of controllers. In one example, the controller 112 is or includes at least one processor. In another example, the controller 112 performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated that various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. An Uninterruptible Power Supply (UPS), comprising:
a first power path including
a first input,
a rectifier coupled to the first input,
at least one DC bus coupled to the rectifier,
an inverter coupled to the at least one DC bus, and
an output coupled to the inverter;
a second power path including a second input and a bypass switching device, the second input selectively coupled to the output through the bypass switching device, the second power path bypassing the first input, the rectifier, and the at least one DC bus; and
at least one controller configured to
control the bypass switching device to be in a conducting state to conduct power from the second input to the output,
determine an operating quadrant of the inverter,
determine a voltage of the at least one DC bus, and
while the bypass switching device is in the conducting state, limit a maximum magnitude of an output current of the inverter based at least in part on the operating quadrant and the voltage of the at least one DC bus.

2. The UPS of claim 1, wherein determining the operating quadrant of the inverter includes receiving a sense signal of a voltage at the output and determining a requested output current of the inverter.

3. The UPS of claim 1, wherein the at least one controller is further configured to determine whether a magnitude of the voltage of the at least one DC bus is above a voltage threshold, and limiting the maximum magnitude of the output current of the inverter based at least in part on the operating quadrant and the voltage of the at least one DC bus is performed in response to determining that the magnitude of the voltage of the at least one DC bus is above the voltage threshold.

4. The UPS of claim 3, wherein limiting the maximum magnitude of the output current of the inverter based at least in part on the operating quadrant and the voltage of the at least one DC bus is performed based on a linear scaling factor between the maximum magnitude of the output current of the inverter and the magnitude of the voltage of the at least one DC bus.

5. The UPS of claim 3, wherein the voltage threshold corresponds to at least one of a shutdown threshold of the inverter or a voltage rating level of a capacitive element coupled to the at least one DC bus.

6. The UPS of claim 1, wherein limiting the maximum magnitude of the output current of the inverter includes limiting a maximum magnitude of a crest factor of the output current of the inverter.

7. The UPS of claim 1, wherein limiting the maximum magnitude of the output current of the inverter based at least in part on the operating quadrant and the voltage of the at least one DC bus is performed in response to determining that the operating quadrant is a quadrant in which power conducts into the inverter from the second input.

8. The UPS of claim 1, wherein the operating quadrant is a quadrant in which an output voltage of the inverter and the output current of the inverter have opposite polarities.

9. The UPS of claim 1, wherein limiting the maximum magnitude of the output current of the inverter is performed further based on a net power output of the UPS within a line cycle of the inverter.

10. The UPS of claim 9, wherein limiting the maximum magnitude of the output current of the inverter further based on the net power output of the UPS within the line cycle of the inverter includes determining that the net power output of the UPS within the line cycle of the inverter is negative.

11. The UPS of claim 1, wherein the at least one DC bus includes a positive DC bus and a negative DC bus, and limiting the maximum magnitude of the output current of the inverter includes balancing a voltage of the positive DC bus and a voltage of the negative DC bus within a line cycle of the inverter.

12. The UPS of claim 1, wherein the first power path further includes a DC/DC converter coupled to the at least one DC bus and configured to be coupled to an energy-storage device.

13. At least one non-transitory computer-readable medium storing thereon sequences of computer-executable instructions for operating an uninterruptible power supply (UPS), the UPS including a first power path including a first input, a rectifier coupled to the first input, at least one DC bus coupled to the rectifier, an inverter coupled to the at least one DC bus, and an output coupled to the inverter, and a second power path including a second input and a bypass switching device, the second input coupled to the output through the bypass switching device, the second power path bypassing the first input, the rectifier, and the at least one DC bus, the sequences of computer-executable instructions including instructions that instruct at least one processor to:
control the bypass switching device to be in a conducting state to conduct power from the second input to the output;
determine an operating quadrant of the inverter;
determine a voltage of the at least one DC bus; and
while the bypass switching device is in the conducting state, limit a maximum magnitude of an output current of the inverter based at least in part on the operating quadrant and the voltage of the at least one DC bus.

14. The at least one non-transitory computer-readable medium of claim 13, wherein determining the operating quadrant of the inverter includes receiving a sense signal of a voltage at the output and determining a requested output current of the inverter.

15. The at least one non-transitory computer-readable medium of claim 13, wherein the instructions further instruct the at least one processor to determine whether a magnitude of the voltage of the at least one DC bus is above a voltage threshold, and limiting the maximum magnitude of the output current of the inverter based at least in part on the operating quadrant and the voltage of the at least one DC bus is performed in response to determining that a magnitude of the voltage of the at least one DC bus is above a voltage threshold.

16. The at least one non-transitory computer-readable medium of claim 15, wherein limiting the maximum magnitude of the output current of the inverter based at least in part on the operating quadrant and the voltage of the at least one DC bus is performed based on a linear scaling factor between the maximum magnitude of the output current of the inverter and the magnitude of the voltage of the at least one DC bus.

17. The at least one non-transitory computer-readable medium of claim 15, wherein the voltage threshold corresponds to at least one of a shutdown threshold of the inverter or a voltage rating level of a capacitive element coupled to the at least one DC bus.

18. The at least one non-transitory computer-readable medium of claim 13, wherein limiting the maximum magnitude of the output current of the inverter based at least in part on the operating quadrant and the voltage of the at least one DC bus is performed in response to determining that the operating quadrant is a quadrant in which power conducts into the inverter from the second input.

19. The at least one non-transitory computer-readable medium of claim 18, wherein the operating quadrant is a quadrant in which an output voltage of the inverter and the output current of the inverter have opposite polarities.

20. At least one non-transitory computer-readable medium storing thereon sequences of computer-executable instructions for operating an uninterruptible power supply (UPS), the UPS including at least one DC bus, an inverter coupled to at least one DC bus, and an output coupled to the inverter and configured to be coupled to at least one load, the sequences of computer-executable instructions including instructions that instruct at least one processor to:
control the inverter to draw power from the at least one load;
determine an operating quadrant of the inverter;
determine a voltage of the at least one DC bus; and
limit a maximum magnitude of an output current of the inverter derived from the power drawn from the at least one load based at least in part on the operating quadrant and the voltage of the at least one DC bus.
